(19) United States
(12) Patent Application Publication
(10) Pub. No.: US 2025/0371381 A1
(43) Pub. Date: Dec. 4, 2025

(54) HETEROGENOUS ACCELERATORS FOR EFFICIENT GENERATIVE LLM INFERENCE USING PHASE SPLITTING

(71) Applicant: Microsoft Technology Licensing, LLC, Redmond, WA (US)

(72) Inventors: Esha CHOUKSE, Seattle, WA (US); Aashaka Dhaval SHAH, Seattle, WA (US); Chaojie ZHANG, Redmond, WA (US); Ricardo Gouvêa BIANCHINI, Bellevue, WA (US); Inigo GOIRI PRESA, Bellevue, WA (US)

(21) Appl. No.: 18/676,486

(22) Filed: May 28, 2024

(51) Int. Cl. G06N 5/04; G06F 9/455

(52) U.S. Cl. CPC G06N 5/04; G06F 9/45558

(57) ABSTRACT

A system and method for splitting a prompt and token generation phase in a generative large language model (LLM) inference onto separate virtual machines (VMs) is provided. Two separate pools of VMs for prompt and token processing are maintained. The VMs in each of the pools are pre-loaded with a model of choice. A scheduler allocates an inference to a prompt VM from a pool of prompt VMs and a token VM from a pool of token VMs. Context generated from layers of the generative LLM during the prompt computation is saved in a key-value (KV) cache that is transferred from the prompt VM to token VM as it is used for all the future token generation iterations.

### BACKGROUND

Recent innovations in generative large language models (LLMs) have made their applications and use-cases ubiquitous. This has led to large-scale deployments of these models, using complex, expensive, and power-hungry AI accelerators, most commonly, graphic processing units (GPUs). These developments make LLM inference efficiency an important challenge. Generative LLMs have seen a lot of progress in response quality and accuracy recently. This has led to a wide adoption of LLMs for various use-cases. Most modern LLMs are based on trans-formers and share very similar characteristics. Most of these models are large and run on expensive and power-hungry GPUs. The sudden large-scale deployment of LLMs has led to a world-wide GPUs capacity crunch.

Further, while it is important to train these LLMs efficiently, a bulk of datacenters and machines are being used for inference based on the vast number of use-cases that leverage LLMs. Furthermore, a cost of training these models is very high and requires dedicated super-computers. A large number of inferences is the way to amortize/offset the high training costs. LLM inference jobs, although orders of magnitude smaller than training, are still expensive given the compute involved. The model size (the number of parameters in transformers models) has grown steadily, from the early models having 340 million parameters to 175 billion parameters.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Example solutions for executing a generative large language model (LLM) include: receiving an inference request; assigning a first VM from a first pool of virtual machines (VMs) to the inference request, wherein each VM in the first pool of VMs is assigned to a first type of graphics processing unit (GPU) based on the first pool of VMs performing prompt computations associated with inference request; assigning a second VM from a second pool of VMs to the inference request, wherein each VM in the second pool of VMs is assigned to a second type of GPU based on the second pool of VMs performing token generation associated with the inference request; determining that a context from a calculation of a first layer in the generative LLM by the first VM is stored in a key-value (KV) cache; based on the determining, transferring the KV-cache to the second VM; and causing the second VM to generate one or more output tokens based at least on the context in the KV-cache.

### BRIEF DESCRIPTION OF THE DRAWINGS

The present description will be better understood from the following detailed description read considering the accompanying drawings, wherein:

FIG. 1 is a flow diagram illustrating an example of an LLM inference;

FIG. 2 is a block diagram illustrating an example of a system for splitting the prompt phase and the token phase of a generative LLM inference on to separate VMs;

FIG. 3 is a flowchart illustrating an example method for executing a generative LLM using the system of FIG. 2.

FIG. 4 illustrates an example computing apparatus as a functional block diagram.

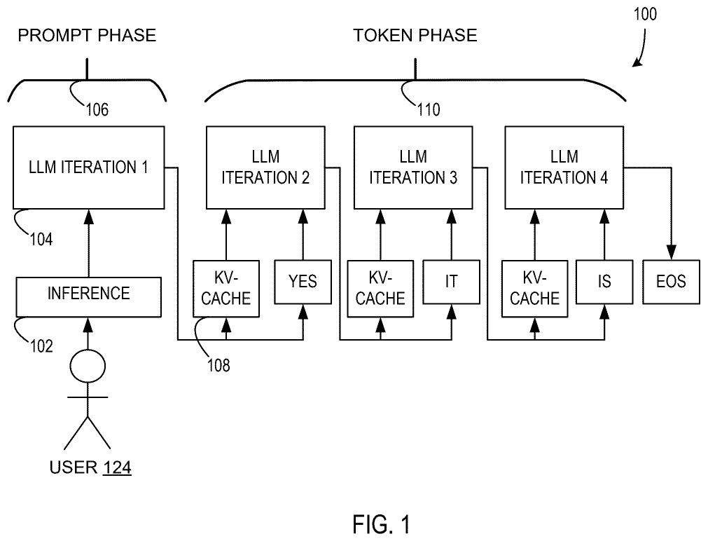

Corresponding reference characters indicate corresponding parts throughout the drawings. In FIGS. 1 to 4, the systems are illustrated as schematic drawings. The drawings may not be to scale. Any of the figures may be combined into a single example or embodiment.

### DETAILED DESCRIPTION

Aspects of the disclosure provide a system and method for splitting a prompt and token generation phase in a generative large language model (LLM) inference onto separate virtual machines (VMs). The prompt phase is run on a larger, more power-hungry graphics processing unit (GPU) and the token generation phase is run on a GPU with high memory bandwidth. Two separate pools of VMs for prompt and token processing are maintained. The VMs in each of the pools are pre-loaded with a model of choice. A scheduler allocates an inference to a prompt VM from a pool of prompt VMs and a token VM from a pool of token VMs. Context generated from layers of the generative LLM during the prompt computation is saved in a key value (KV) cache that is transferred from the prompt VM to token VM as it is used for all the future token generation iterations.

Generative LLM inference in all conventional models for a single request consists of several forward passes of the model, as the output tokens are generated one by one. This inherently has two contrasting phases of computation. First, the prompt computation phase where all tokens in an input prompt run through a forward pass of the model in parallel, to generate a first output token. The prompt computation phase tends to be computationally intensive and requires a high floating point operations per second (FLOPs) of the latest GPUs being produced. Second, the token generation phase, which tends to be more serialized in nature as each token is generated based on the forward pass of the last token and all the cached context from previous tokens in the sequence. Given the lack of parallelism in token generation phase computation, the token generation phase tends to be more memory bandwidth and capacity bound, despite state-of-the-art batching.

For example, FIG. 1 provides an illustrative example of a conventional generative LLM inference process the demonstrates the two phases (e.g., prompt and token phases). When a prompt query is received at 102, all input tokens are computed in parallel at 104, in a single iteration to generate a first token. This first phase is considered the prompt processing phase (e.g., a prompt phase 106). The context generated from attention layers during the prompt computation in the prompt phase 106 is saved in a KV-cache 108, since it is needed for all the future token generation iterations (e.g., LLM iterations 2, 3, and 4) in a token generation phase 110. After the first token is generated, the following tokens only use the last generated token and the KV-cache 108 as inputs to the forward pass of the model in the token generation phase 110. This makes the subsequent token generation more memory bandwidth and capacity intensive than the computationally heavy prompt phase.

When hosting VMs, cloud providers need to consider the peak power draw, which has a direct impact on the datacenter cost. This is especially important when building clusters for GPUs since they consume much higher power than regular compute machines. As the prompt phase is compute intensive, the power draw increases with the batch size. On the other hand, the token phase is memory bound and the power draw does not vary when increasing the number of tokens to process. Providers can cap the power usage of the VMs to reduce the peak power. However, the prompt phase is highly sensitive to the power cap and the latency increases substantially, while the token generation phase sees almost no impact in latency when power capping by over 50% (e.g., 700 W to 350 W).

As such, running both prompt computation phase and the token generation phase on the same VM leads to inconsistent end-to-end latency. Due to these challenges, services need to over-provision these expensive GPUs to meet tight inference service level objectives (SLOs). On the other hand, cloud service providers (CSPs) are building many new datacenters for GPU expansions, and running into a power wall. In addition, the industry continues to release more and more computationally able GPUs, each much more power-hungry and expensive than the previous one. However, the high-bandwidth memory (HBM) capacity and bandwidth on these GPUs has not scaled at the same rate recently, with computation and power increasing at a much greater rate than memory bandwidth and no increase in memory capacity.

Each of the prompt computation phase and the token generation phase have distinct latency, throughput, memory, and power characteristics. Despite state-of-the-art batching and scheduling, the token generation phase underutilizes compute resources. Thus, unlike the compute-intensive prompt computation phase, the token generation phase does not require the compute capability of the latest GPUs, and can be run with lower power and cost.

Given the different characteristics of prompt and token generation phases, the examples described herein advantageously run the prompt and token generation phases on different hardware (e.g., different GPUs). While the prompt phase utilizes the power budget of the GPU efficiently, the token phase does not. As such, an LLM inference deployment cluster is sized appropriately with a right number of prompt VMs that run the prompt phase and a right number of token VMs to run the token phase.

The disclosure operates in an unconventional manner at least by splitting the prompt computation phase and the token generation phase of an LLM inference request onto separate VMs. Splitting the two phases onto separate VMs increases utilization and enables a use of hardware that is well-suited for each phase and the ability to provision resources independently per phase. In addition, by splitting the two phases, this opens up a new exploration space as the VM pools for the two phases can be designed and scaled separately. While splitting an inference request across VMs calls for state transfer from the VM running a prompt computation over to the VM running token generation, the systems described herein implement and optimize this state transfer using a fast back-plane that interconnects available in GPU clusters. GPU clusters are designed to optimize cost, throughput, and power, based on production traces of LLM inference requests. Given the diverging memory and compute expansions over generations of GPUs, different GPUs and power caps can be evaluated for different inference phases. This enables better performance per dollar (Perf/$) for users, and better performance per watt (Perf/W) for cloud service providers.

In addition, the systems and methods described herein design LLM inference clusters using different types of VMs for the prompt computation and token generation phases, enabling the clusters to be optimized for the three key objectives: throughput, cost, and power while also performing well even as workloads change. Examples described herein enable, under latency SLOs, an ability to achieve 1.4× higher throughput at 20% lower cost than current designs, 1.76× increased throughput with 15% lower power at the same cost, or 2.35× increased throughput with same cost and power budgets.

In some examples, the systems and methods herein utilize the same GPUs for both prompt VMs and token VMs (e.g., DGX-H100 by NVIDIA™, which have 3.43× more compute and 1.75× more power as compared to their predecessor GPUs (e.g., DGX-A100 by NVIDIA™) and the memory bandwidth increase was limited to 1.6×, with no increase in memory capacity). In this example, a power cap is placed on the token VMs down to 70% of their rated power, with each GPU capped by 50% of the power. This is advantageous based on the prompts phase being impacted by power caps while token has no performance impact with 50% lower power cap per GPU. In another example, the systems and methods herein utilize two different GPUs for prompt VMs and token VMs, respectively. For example, DGX-H100 type for prompt machines and DGX-A100 for the token pool as the memory and computer ratio favors DGX-A100 compared to the DGX-H100) and DGX-A100s can be more cost and power-efficient for the token phase.

Further, conventional LLMs are based on transformers. Transformer models use attention and multi-layer-perceptron layers to understand the inputs and generate an output, respectively. Transformer-based LLMs can consist of encoder-only, decoder-only, or encoder-decoder models. In some examples, the generative LLMs described herein are either decoder-only or encoder-decoder models.

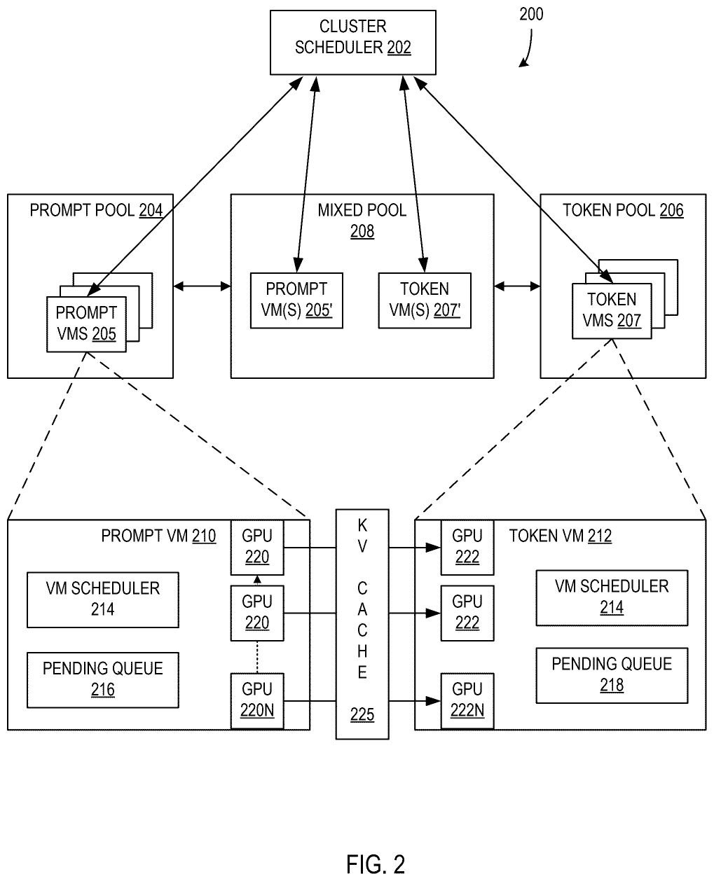

FIG. 2 is a block diagram illustrating an example system 200 configured for splitting the prompt phase 106 and the token phase 110 of the generative LLM inference on to separate VMs. In some examples, one or more of the VMs described herein are not used and the system and methods described herein utilize bare-metal servers. In some examples, the system 200 uses a hierarchical two-level scheduling. A cluster scheduler 202 being responsible for routing incoming requests to particular VMs and a re-purposing of VMs and a VM scheduler 214 that maintains a pending queue and manages batching of requests at each VM in each of a prompt pool 204 and a token pool 206. The VM scheduler 214 runs on each VM and is responsible for tracking GPU memory utilization, maintaining pending queues, selecting a batch size and batched requests for each iteration, and reporting relevant status to the cluster scheduler 202.

The cluster scheduler 202 maintains the prompt pool 204 and the token pool 206 for processing prompt (e.g., the prompt phase 106) and token processing (e.g., the token phase 110), and assigns VMs to a pool depending on the input/output token distribution and an expected load (i.e., requests per second). In some examples, at a lower request rate, a better latency is targeted while at a higher request rate, avoiding any performance or throughput reduction due to the fragmentation is targeted between prompt pool 204 and the token pool 206. In some examples, to meet service level objectives (SLOs) and avoid any performance cliffs due to fragmentation at higher loads, the system 200 described herein also maintains a mixed pool 208 that includes one or more VMs from the prompt pool 204 and/or the token pool 206. Thus, in addition to the prompt pool 204 and the token pool 206, the mixed pool 208 of VMs, which includes the only set of VMs where mixed batches apply, the system 200 uses mixed continuous batching.

As described in further detail below, VMs in the prompt pool 204 (e.g., prompt VMs 205) and VMs in the token pool 206 (e.g., token VMs 207) are pre-loaded with a model (e.g., GPU) of choice. In some examples, the prompt pool 204 includes prompt VMs (e.g., the prompt VMs 205) that comprise high compute capability with high (enough) memory bandwidth. However, the prompt VMs 205 have less memory capacity (e.g., they do not need a high level of memory capacity) than the VMs in the token pool 206. In some examples, the token pool 206 includes the token VMs (e.g., the token VMs 207) comprise a high memory capacity and bandwidth. However, the token VMs 207 have less (e.g., they do not need a high level of compute compacity) compute capacity than the prompt VMs 205. The examples described herein enable this hardware design space exploration for each phase (e.g., the prompt and token phases) independently.

In some examples, each VM in the prompt pool 204, the token pool 206, and the mixed pool 208, communicates to the cluster scheduler 202 any change in its memory capacity or pending queue. In one example, this does not necessarily happen at every single iteration boundary. Then, the cluster scheduler 202 uses Join the Shortest Queue (JSQ) scheduling to assign a prompt and a token VM to each request upon arrival. In one example, the token VM is assigned upon arrival to minimize the KV-cache transfer overhead.

For example, when a new inference request arrives, the cluster scheduler 202 allocates the new inference to a pair of VMs, for example, a prompt VM (e.g., prompt VM 210) from the prompt pool 204 and a token VM (e.g., token VM 212) from the token pool 206. The prompt VM 210 is responsible for generating a first token for an input query for the inference, by processing all the input prompt tokens in the prompt phase and generating a KV-cache 225 (e.g., a cache corresponding to a context of the prompt computation). The prompt VM 210 transfers the KV-cache 225 to the token VM 212, which continues the token generation until the response is complete and continuous batching at the token VMs 207 is used to maximize their utilization.

In some examples, requests reaching the VM scheduler 214 are batched for higher throughput. In some examples, a default mechanism only batches at the request-level. In this case, ready requests are batched together, but all the forward passes for these requests are completed before any other requests are run. Since requests can have long token generation phases, this can lead to long wait times for requests arriving in between, causing high time to first token (TTFT) and high end-to-end (E2E) latencies. In one example, an optimization is continuous batching. In this case, the scheduling decisions are made before each forward pass. However, in some examples, any given batch comprises either purely of prompt phase, or only token phase. In one example, the prompt phase is considered more important since it impacts the prompt phase (i.e., TTFT). Hence, a waiting prompt can preempt a token phase. Although this leads to shorter TTFT, it can increase the tail for TBT, and therefore E2E by a lot. Further, there is mixed batching where the scheduling decisions are made at each forward pass, and the prompt and token phases can run together. In the examples described herein, mixed batching is utilized. In some examples, the prompt phase batch size is limited to ensure good performance. In contrast, batching the token generation phase yields high throughput without any downside. Further, batching during the prompt phase is compute-bound, whereas the token phase is limited by memory capacity.

Further, with respect to model parallelism, given the increasing model sizes, model parallelism is no longer just applicable to training, but also inference. Model parallelism can be used to divide a model onto multiple GPUs, and even multiple VMs. There are two types of model parallelism used in inference: pipeline and tensor. Pipeline parallelism (PP) divides the layers of the model among the GPUs, while keeping all the operators and tensors within a layer on the same GPU. Tensor parallelism (TP) on the other hand, divides the tensor across the GPUs, while replicating all the layers on each GPU. Pipeline parallelism requires lower communication across the participating GPUs, while tensor parallelism requires high bandwidth communication for each layer. In general, tensor parallelism is known to be better performing for GPUs within the same machine, connected with very high bandwidth interconnect. In the examples described herein, tensor parallelism is utilized across GPUs for the best latency.

The mixed pool 208 dynamically increases and decreases the number VMs maintained therein without any noticeable pool-switching latency, based on request rates and distributions of input and output tokens. In some examples, a VM in the mixed pool 208 retains its original identity as a prompt VM or token VM and the cluster scheduler 202 sends the respective VM back to its original pool once there are no tasks of the opposite kind in the pending queue of the respective VM.

In some examples, when the cluster scheduler 202 attempts to assign a prompt VM (e.g., from the prompt pool 204) and a token VM (e.g., from the token pool 206) for a request using JSQ and the cluster scheduler 202 finds that the queue in a selected VM is beyond a threshold, the cluster scheduler 202 looks for target VMs in the mixed pool 208. However, if the mixed pool 208 is also full (e.g., the queues in the mixed pool 208 are above a threshold), the cluster scheduler 202 proceeds to look in an opposite pool (i.e., a token VM in the token pool 206 to run prompts or a prompt VM in the prompt pool 204 to run tokens) and moves the respective VM into the mixed pool 208. In some examples, VMs in the mixed pool 208 operate with mixed batching.

In some examples, once the queue of mixed requests is drained in the mixed pool 208, the cluster scheduler 202 transitions/moves a VM back to its original pool. For example, when the queue in the token pool 206 is too long, the cluster scheduler 202 moves a prompt VM from the prompt pool 204 to the mixed pool 208 to run tokens, and once the prompt VM is done running tokens, the cluster scheduler 202 transitions/moves the prompt VM back into the prompt pool 204.

In some examples, while the cluster scheduler 202 maintains the prompt pool 204, and mixed pool 208, and the token pool 206, and assigns VMs to a pool depending on the input/output token distribution and an expected load (i.e., requests per second), when these values deviate considerable from an initial assumption, a coarse granularity re-purposing of VMs is employed by moving VMs between the prompt pool 204 and the token pool 206. In some examples, re-purposing a VM is performed one-by-one during times of lower utilization on a cluster. In one example, the re-purposing of VMs is triggered when a threshold percent of VMs (e.g., 10% of VMs) stay in the mixed pool 208 for a long threshold of time (e.g., 30 minutes).

For each VM in the prompt pool 204, the mixed pool 208, and the token pool 206, the VM scheduler 214 communicates to the cluster scheduler 202 any change a respective VM's capacity or pending queue. In one example, this does not happen at every single iteration boundary. The cluster scheduler 202 uses Join the Shortest Queue (JSQ) scheduling to assign a prompt VM (e.g., the prompt VM 210) and a token machine (e.g., the token VM 212) to each request upon arrival. In one example, the token VM 212 is assigned upon arrival to minimize transfer overhead for the KV-cache 225.

As explained above, the VM scheduler 214 runs on each VM in the prompt pool 204, the token pool 206, and the mixed pool 208 and is responsible for tracking GPU memory utilization, maintaining the pending queue, selecting the batch size and the batched requests for each iteration, and reporting the relevant status to the cluster scheduler 202. In some examples, for prompt VMs in the prompt pool 204, the VM scheduler 114 uses first-come-first-serve (FCFS) to schedule prompts. In some examples, after a threshold number of prompt tokens (e.g., after 2048 prompt tokens) a throughput degrades. Thus, in these examples, the VM scheduler 214 restricts the batching of multiple prompts together to, for example, 2048 tokens in total. The threshold number of tokens is a configurable value, and changes for a different model or hardware.

For token VMs in the token pool 206, the VM scheduler 214 uses FCFS to schedule tokens and batches as much as possible in some examples. Token generation throughput scales up with the batch size until a token VM runs out of memory. As such, the VM scheduler 214 tracks memory and starts queueing tokens once the token VM is close to running out of memory.

In some examples, to meet the SLOs for TTFT, the VM scheduler 214 prioritizes running prompts and schedules any new prompts in the pending queue immediately. If the VM was running a token phase and there is no capacity, the VM scheduler 214 preempts tokens. To avoid starvation of the token phase due to preemption, the VM scheduler 214 increases a priority of the token with age and limit the number of preemptions each token can have.

As explained above, the KV-cache 225 is generated during the prompt phase of the request, and constantly grows during its token generation phase. However, as a result of splitting a prompt and token generation phase in an LLM inference onto separate VMs, the KV-cache 225 needs to be transferred from the prompt VM to the token VM to avoid any duplicate computation. To reduce the overhead that the system 200 might add on the LLM inference cluster, the system 200 optimizes the KV-cache 225 transfer by overlapping the transferring of the KV-cache 225 with a computation in the prompt phase. For example, as each layer in the LLM is calculated in a prompt VM, the KV-cache 225 corresponding to that layer is also generated. At the end of each layer, an asynchronous transfer of the KV-cache 225 is triggered for that layer while the prompt computation continues to the next layer. Layer-wise transfers also allow other optimizations, such as earlier start of the token phase in the token VMs, as well as earlier release of KV-cache 225 on the prompt VMs.

In some examples, for small prompt sizes (e.g., less than 1K tokens), the KV-cache 225 is small (e.g., smaller than a threshold size) and it is not necessary to pay overheads of fine-grained layer-wise synchronization required by per-layer transfer. In some examples, given the number of tokens in a batch is already known at the start of computation, the system 200, and in particular, the VM scheduler 214, picks the best technique for transferring of the KV-cache 225. For example, for small prompts, the system 200 uses serialized KV-cache transfer, and for larger prompts sizes, the system 200 uses the per-layer transfer.

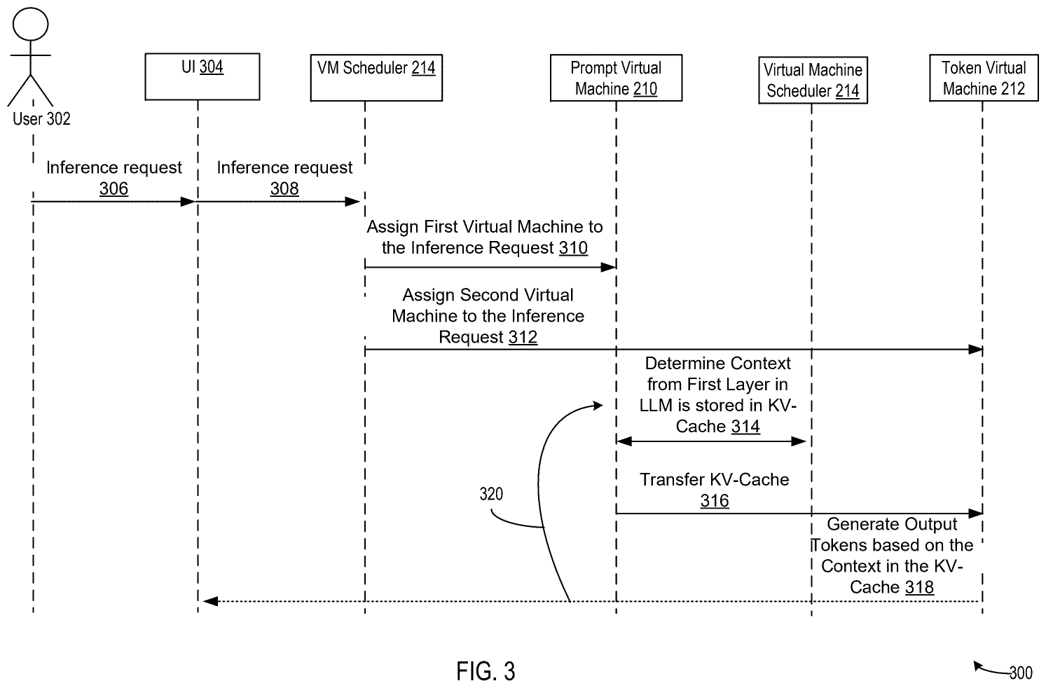

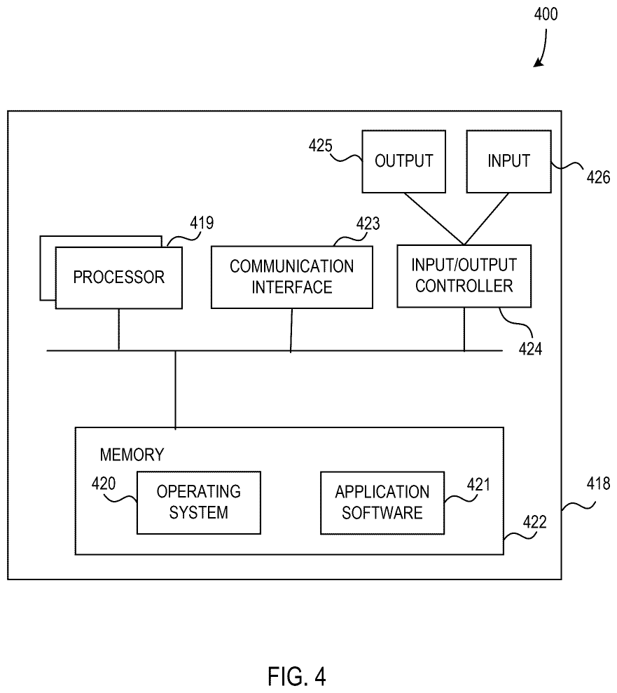

FIG. 3 is a flowchart illustrating an example method 300 for executing a generative LLM. In some examples, the method 300 is executed or otherwise performed by or in association with a system such as system 200 of FIG. 2, and/or by one or more processors, such as the processors 419 described in further detail below with respect to FIG. 4.

At 306, a query from a user 302 is received at user interface 304. In some examples, the query includes one or more words or other search terms that are used as input to, for example, a search engine associated with the system 200. In some examples, the user 302 submits a query from a computing device. In some examples, the query includes one or more words or other search terms that are used as input. The query is received (e.g., at 306) by the user interface 304 of a machine learning platform (e.g., the system 200) that uses techniques, such as, natural language processing (NLP) to determine an inference from the query. In some examples, as the query is received at 306 by the user interface 304, it is either forwarded or accessed/received by the VM scheduler 214 at 308.

At 310, the VM scheduler 214 assigns a first VM (e.g., the prompt VM 210) from a first pool of VMs (e.g., the prompt pool 204) to the inference request. In some examples, each VM in the first pool of VMs is assigned to a first type of GPU based on the first pool of VMs performing prompt computations associated with inference requests. For example, the first pool of VMs comprise high compute capability with high (enough) memory bandwidth.

At 312, the cluster scheduler 202 assigns a second VM (e.g., the token VM 212) from a second pool of VMs (e.g., the token pool 206) to the inference request. In some examples, each VM in the second pool of VMs is assigned to a second type of GPU based on the second pool of VMs performing token generation associated with the inference request. For example, the second pool of VMs comprise a high memory capacity and bandwidth. That is, the token VM 212 has less compute capacity (e.g., it does not need a high level of compute compacity) than the prompt VM 210 and as much or higher memory capacity than the prompt VM 210.

At 314, the VM scheduler 214 determines that a context from a calculation of a first layer in the generative LLM by the prompt VM 210 is stored in a KV-cache (e.g., the KV-cache 225). At 316, based on the determining, the KV-cache 225 is transferred to the token VM 212. At 318, the token VM 212 generates one or more output tokens based at least on the context in the KV-cache 225.

In some examples, at least operations 314-318 are repeated at 320 until an output from the generated tokens is formed and presented to the user 302 via the user interface 304. That is, a component (e.g., a decoding mechanism) not shown forms an output from generated tokens that are based on predictions of a likelihood of each token (word or subword) given the context. The decoding mechanism takes the output probabilities of tokens generated and decides which token to output at each step. It may use different strategies such as greedy decoding (choosing the token with the highest probability at each step), beam search (exploring multiple token sequences based on probabilities and keeping the most likely ones), or sampling (randomly selecting tokens based on their probabilities, potentially introducing randomness into the output). As tokens are generated and selected by the decoding mechanism, they are concatenated together to form the final output sequence, which can be a sentence, paragraph, or any other structured text depending on the task. After the tokens are generated and concatenated, post-processing steps may be applied to refine the output, such as removing special tokens, adjusting punctuation, or ensuring grammatical correctness, and presented to the user 302 via the user interface 304.

### Exemplary Operating Environment

The present disclosure is operable with a computing apparatus according to an embodiment as a functional block diagram 400 in FIG. 4. In an example, components of a computing apparatus 418 (e.g., a server) are implemented as a part of an electronic device according to one or more embodiments described in this specification. The computing apparatus 418 comprises one or more processors 419 which may be microprocessors, controllers, or any other suitable type of processors for processing computer executable instructions to control the operation of the electronic device. Alternatively, or in addition, the processor 419 is any technology capable of executing logic or instructions, such as a hard-coded machine. In some examples, platform software comprising an operating system 420 or any other suitable platform software is provided on the apparatus 418 to enable application software 421 to be executed on the device.

In some examples, computer executable instructions are provided using any computer-readable media that is accessible by the computing apparatus 418. Computer-readable media include, for example, computer storage media such as a memory 422 and communications media. Computer storage media, such as a memory 422, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 422) is shown within the computing apparatus 418, it will be appreciated by a person skilled in the art, that, in some examples, the storage is distributed or located remotely and accessed via a network or other communication link (e.g., using a communication interface 423).

Further, in some examples, the computing apparatus 418 comprises an input/output controller 424 configured to output information to one or more output devices 425, for example a display or a speaker, which are separate from or integral to the electronic device. Additionally, or alternatively, the input/output controller 424 is configured to receive and process an input from one or more input devices 426, for example, a keyboard, a microphone, or a touchpad. In one example, the output device 425 also acts as the input device. An example of such a device is a touch sensitive display. The input/output controller 424 may also output data to devices other than the output device, e.g., a locally connected printing device. In some examples, a user provides input to the input device(s) 426 and/or receives output from the output device(s) 425.

The functionality described herein can be performed, at least in part, by one or more hardware logic components. According to an embodiment, the computing apparatus 418 is configured by the program code when executed by the processor 419 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), and GPUs.

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a set of processors; a plurality of VMs; a first scheduler causing a first processor in the set of processors to perform the following operations: assign, from the plurality of VMs, a first set of VMs to a first pool of VMs, wherein each VM in the first pool of VMs is assigned to a first type of GPU based on the first pool of VMs performing prompt computations associated with inference requests; assign, from the plurality of VMs, a second set of VMs to a second pool of VMs, wherein each VM in the second pool of VMs is assigned to a second type of GPU based on the second pool of VMs performing token generation associated with the inference requests; and a second scheduler causing a second processor in the set of processors to perform the following operations: receiving an inference request; assign a first VM from the first pool of VMs to the inference request; assign a second VM from the second pool of VMs to the inference request; determine that a context from a calculation of a first layer in the generative LLM by the first VM is stored in a KV-cache; based on the determining, transfer the KV-cache to the second VM; and cause the second VM to generate one or more output tokens based at least on the context in the KV-cache.

An example method comprises: receiving an inference request; assigning a first VM from a first pool of VMs to the inference request, wherein each VM in the first pool of VMs is assigned to a first type of GPU based on the first pool of VMs performing prompt computations associated with inference request; assigning a second VM from a second pool of VMs to the inference request, wherein each VM in the second pool of VMs is assigned to a second type of GPU based on the second pool of VMs performing token generation associated with the inference request; determining that a context from a calculation of a first layer in the generative LLM by the first VM is stored in a KV-cache; based on the determining, transferring the KV-cache to the second VM; and causing the second VM to generate one or more output tokens based at least on the context in the KV-cache.

One or more computer storage media having computer-executable instructions that, upon execution by a set of processors, cause the set of processors to perform the following operations: assigning, from a plurality of VMs, a first set of VMs to a first pool receiving an inference request; assigning a first VM from a first pool of VMs to the inference request, wherein each VM in the first pool of VMs is assigned to a first type of GPU based on the first pool of VMs performing prompt computations associated with inference request; assigning a second VM from a second pool of VMs to the inference request, wherein each VM in the second pool of VMs is assigned to a second type of GPU based on the second pool of VMs performing token generation associated with the inference request; determining that a context from a calculation of a first layer in the generative LLM by the first VM is stored in a KV-cache; based on the determining, transferring the KV-cache to the second VM; and causing the second VM to generate one or more output tokens based at least on the context in the KV-cache.

Alternatively, or in addition to the other examples described herein, examples include any combination of the following:
wherein a first quantity of VMs is assigned to the first pool of VMs and a second quantity of VMs is assigned to the second pool of VMs based on input and output token distribution and an expected inference request per second.
further comprising: a third pool of VMs, the third pool of VMs comprising a third set of VMs that are assigned to either the first type of GPU or the second type of GPU; and wherein the first scheduler further causes the first processor in the set of processors to perform the following operations: receive a second inference request; determine that third VM in the first pool of VMs has a queue that is above a queue threshold level; and based on determining that third VM in the first pool has a queue that is above the queue threshold level, assign a fourth VM from the mixed pool of VMs to the second inference request, wherein the fourth VM is currently assigned to the second type of GPU.
wherein the first scheduler further causes the first processor in the set of processors to perform the following operations: determine that the third VM in the first pool no longer has a queue that is above the queue threshold level; and based on determining that that the third VM in the first pool no longer has a queue that is above the queue threshold level, re-assign the fourth VM to the second pool of VMs.
wherein the second scheduler further causes the second processor in the set of processors to perform the following operations: determine that a second context from a calculation of a second layer in the generative LLM by the first VM is stored in the KV-cache; based on the determining, transfer the KV cache to the second VM; and cause the second VM to generate a second output token based at least on the second context in the KV cache.
wherein the first type of GPU has a higher compute capability than the second type of GPU, and wherein the second type of GPU one or more of the following: a power threshold that is lower than the power threshold of the first type of GPU, and a memory capacity that is higher than the memory capacity of the first type of GPU.
wherein the VMs in the second pool of VMs do not perform prompt computations.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for based on the query, selecting a website; exemplary means for identifying a plurality of media on the website; exemplary means for based at least on the query, selecting a portion of the plurality of media on the website; exemplary means for extracting content from each of the selected portion of the plurality of media based on the query; exemplary means for generating semantic summaries of the extracted content; exemplary means for aggregating the semantic summaries into an aggregated semantic summary; and exemplary means for providing the aggregated semantic summary to the user.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system hosting a generative large language model (LLM), the system comprising:
a set of processors;
a plurality of virtual machines (VMs);
a first scheduler causing a first processor in the set of processors to perform the following operations:
assign, from the plurality of VMs, a first set of VMs to a first pool of VMs, wherein each VM in the first pool of VMs is assigned to a first type of graphics processing unit (GPU) based on the first pool of VMs performing prompt computations associated with inference requests;
assign, from the plurality of VMs, a second set of VMs to a second pool of VMs, wherein each VM in the second pool of VMs is assigned to a second type of GPU based on the second pool of VMs performing token generation associated with the inference requests; and
a second scheduler causing a second processor in the set of processors to perform the following operations:
receiving an inference request;
assign a first VM from the first pool of VMs to the inference request;
assign a second VM from the second pool of VMs to the inference request;
determine that a context from a calculation of a first layer in the generative LLM by the first VM is stored in a key-value (KV) cache;
based on the determining, transfer the KV-cache to the second VM; and
cause the second VM to generate one or more output tokens based at least on the context in the KV-cache.

2. The system of claim 1, wherein a first quantity of VMs is assigned to the first pool of VMs and a second quantity of VMs is assigned to the second pool of VMs based on input and output token distribution and an expected inference request per second.

3. The system of claim 1, further comprising:
a third pool of VMs, the third pool of VMs comprising a third set of VMs that are assigned to either the first type of GPU or the second type of GPU; and
wherein the first scheduler further causes the first processor in the set of processors to perform the following operations:
receive a second inference request;
determine that third VM in the first pool of VMs has a queue that is above a queue threshold level; and
based on determining that third VM in the first pool has a queue that is above the queue threshold level, assign a fourth VM from the third pool of VMs to the second inference request, wherein the fourth VM is currently assigned to the second type of GPU.

4. The system of claim 3, wherein the first scheduler further causes the first processor in the set of processors to perform the following operations:
determine that the third VM in the first pool no longer has a queue that is above the queue threshold level; and
based on determining that that the third VM in the first pool no longer has a queue that is above the queue threshold level, re-assign the fourth VM to the second pool of VMs.

5. The system of claim 1, wherein the second scheduler further causes the second processor in the set of processors to perform the following operations:
determine that a second context from a calculation of a second layer in the generative LLM by the first VM is stored in the KV-cache;
based on the determining, transfer the KV-cache to the second VM; and
cause the second VM to generate a second output token based at least on the second context in the KV-cache.

6. The system of claim 1, wherein the first type of GPU has a higher compute capability than the second type of GPU, and wherein the second type of GPU one or more of the following: a power threshold that is lower than the power threshold of the first type of GPU, and a memory capacity that is higher than the memory capacity of the first type of GPU.

7. The system of claim 1, wherein the VMs in the second pool of VMs do not perform prompt computations.

8. A method of executing a generative large language model (LLM), the method comprising:
receiving an inference request;
assigning a first VM from a first pool of virtual machines (VMs) to the inference request, wherein each VM in the first pool of VMs is assigned to a first type of graphics processing unit (GPU) based on the first pool of VMs performing prompt computations associated with inference request;
assigning a second VM from a second pool of VMs to the inference request, wherein each VM in the second pool of VMs is assigned to a second type of GPU based on the second pool of VMs performing token generation associated with the inference request;
determining that a context from a calculation of a first layer in the generative LLM by the first VM is stored in a key-value (KV) cache;
based on the determining, transferring the KV-cache to the second VM; and
causing the second VM to generate one or more output tokens based at least on the context in the KV-cache.

9. The method of claim 8, wherein a first quantity of VMs is assigned to the first pool of VMs and a second quantity of VMs is assigned to the second pool of VMs based on input and output token distribution and an expected inference request per second.

10. The method of claim 8, further comprising:
assigning a third set of VMs to a third pool of VMs, the third set of VMs that are assigned to either the first type of GPU or the second type of GPU; and
receiving a second inference request;
determining that third VM in the first pool of VMs has a queue that is above a queue threshold level; and
based on determining that third VM in the first pool has a queue that is above the queue threshold level, assigning a fourth VM from the third pool of VMs to the second inference request, wherein the fourth VM is currently assigned to the second type of GPU.

11. The method of claim 10, further comprising:
determining that the third VM in the first pool no longer has a queue that is above the queue threshold level; and
based on determining that that the third VM in the first pool no longer has a queue that is above the queue threshold level, re-assigning the fourth VM to the second pool of VMs.

12. The method of claim 8, further comprising:
determining that a second context from a calculation of a second layer in the generative LLM by the first VM is stored in the KV-cache;
based on the determining, transferring the KV-cache to the second VM; and
causing the second VM to generate a second output token based at least on the second context in the KV-cache.

13. The method of claim 8, wherein the first type of GPU has a higher compute capability than the second type of GPU, and wherein the second type of GPU one or more of the following: a power threshold that is lower than the power threshold of the first type of GPU, and a memory capacity that is higher than the memory capacity of the first type of GPU.

14. The method of claim 8, wherein the VMs in the second pool of VMs do not perform prompt computations.

15. A computer-readable medium comprising computer-executable instructions for executing a generative large language model (LLM), the computer executable instructions causing a set of processors, cause the set of processors to perform the following operations:
assigning, from a plurality of virtual machines (VMs), a first set of VMs to a first pool receiving an inference request;
assigning a first VM from a first pool of VMs to the inference request, wherein each VM in the first pool of VMs is assigned to a first type of graphics processing unit (GPU) based on the first pool of VMs performing prompt computations associated with inference request;
assigning a second VM from a second pool of VMs to the inference request, wherein each VM in the second pool of VMs is assigned to a second type of GPU based on the second pool of VMs performing token generation associated with the inference request;
determining that a context from a calculation of a first layer in the generative LLM by the first VM is stored in a key-value (KV) cache;
based on the determining, transferring the KV-cache to the second VM; and
causing the second VM to generate one or more output tokens based at least on the context in the KV-cache.

16. The computer-readable medium of claim 15, wherein a first quantity of VMs is assigned to the first pool of VMs and a second quantity of VMs is assigned to the second pool of VMs based on input and output token distribution and an expected inference request per second.

17. The computer-readable medium of claim 15, wherein the computer-executable instructions further cause the set of processors to perform the following operations:
assigning a third set of VMs to a third pool of VMs, the third set of VMs that are assigned to either the first type of GPU or the second type of GPU; and
receiving a second inference request;
determining that third VM in the first pool of VMs has a queue that is above a queue threshold level; and
based on determining that third VM in the first pool has a queue that is above the queue threshold level, assigning a fourth VM from the third pool of VMs to the second inference request, wherein the fourth VM is currently assigned to the second type of GPU.

18. The computer-readable medium of claim 17, wherein the computer-executable instructions further cause the set of processors to perform the following operations:
determining that the third VM in the first pool no longer has a queue that is above a queue threshold level; and
based on determining that that the third VM in the first pool no longer has a queue that is above the queue threshold level, re-assigning the fourth VM to the second pool of VMs.

19. The computer-readable medium of claim 15, wherein the computer-executable instructions further cause the set of processors to perform the following operations:
determining that a second context from a calculation of a second layer in the generative LLM by the first VM is stored in the KV-cache;
based on the determining, transferring the KV-cache to the second VM; and
causing the second VM to generate a second output token based at least on the second context in the KV-cache.

20. The computer-readable medium of claim 15, wherein the VMs in the second pool of VMs do not perform prompt computations.
